(19) United States
(12) Patent Application Publication
(10) Pub. No.: US 2013/0101842 A1
(43) Pub. Date: Apr. 25, 2013

(54) PRESSURE-SENSITIVE ADHESIVE TAPE

(71) Applicants: Noboru YOSHIDA, Osaka (JP); Takahisa MIZUTORI, Osaka (JP); Kenta JOZUKA, Osaka (JP); Yoshikazu SOEDA, Osaka (JP)

(72) Inventors: Noboru YOSHIDA, Osaka (JP); Takahisa MIZUTORI, Osaka (JP); Kenta JOZUKA, Osaka (JP); Yoshikazu SOEDA, Osaka (JP)

(21) Appl. No.: 13/655,708

(22) Filed: Oct. 19, 2012

(30) Foreign Application Priority Data
Oct. 20, 2011 (JP) 2011-230985

(51) Int. Cl. C09J 7/02

(52) U.S. Cl. 428/354

(57) ABSTRACT

A pressure-sensitive adhesive tape includes a substrate layer, a colored layer, and a pressure-sensitive adhesive layer. The substrate layer is formed of a plastic material, such as polyethylene terephthalate. The colored layer is laminated on one major surface of the substrate layer. The colored layer is a black printed layer formed by printing, for example, black ink. The pressure-sensitive adhesive layer is laminated on the other major surface of the substrate layer. An acrylic polymer is preferably used as the pressure-sensitive adhesive layer. In the pressure-sensitive adhesive tape, a specular reflectance of visible light on the surface near to the colored layer is 2.0% or smaller.

### BACKGROUND OF THE INVENTION

1. Field of the Invention

The present invention relates to a pressure-sensitive adhesive tape, and more particularly, to a pressure-sensitive adhesive tape in which light reflection on the back surface of the pressure-sensitive adhesive tape is suppressed.

2. Description of the Related Art

A form of a pressure-sensitive adhesive tape in which a pressure-sensitive adhesive layer is formed on one surface of a substrate made of a plastic material is known as conventional and general pressure-sensitive adhesive tapes. The pressure-sensitive adhesive tapes are widely used as joint materials in various industrial fields, such as home electronic appliances, automobiles, and building materials. With the trend, the pressure-sensitive adhesive tapes are often used in visible places. Accordingly, examples of the properties required for a pressure-sensitive adhesive tape include pressure-sensitive adhesive properties, such as pressure-sensitive adhesive force and cohesive force, as well as a surface matting property. For example, a pressure-sensitive adhesive tape, in which the matting property on the surface of the tape near to a pressure-sensitive adhesive layer has been taken into consideration, is known (Patent Document 1).

### PATENT DOCUMENT

[Patent Document 1] Japanese Patent Application Publication No. 2009-155504

However, the matting property on the back surface of a pressure-sensitive adhesive tape (near to the surface on which a pressure-sensitive adhesive layer is not formed) is not sufficient in a pressure-sensitive adhesive tape whose substrate is made of a plastic material (plastic film), and hence the degree of a reflection or a glare, occurring in the surface of the tape, is large. Accordingly, there is the problem that the design of an adherend to which the tape is adhered is impaired.

### SUMMARY OF THE INVENTION

The present invention has been made in view of these situations, and a purpose of the invention is to provide a technique in which: a matting property of a pressure-sensitive adhesive tape is improved; and in particular, a reflection or a glare on the back surface of the tape is reduced.

An embodiment of the present invention is a pressure-sensitive adhesive tape. The pressure-sensitive adhesive tape comprises: a substrate layer made of a plastic material; a colored layer laminated on one major surface of the substrate layer; and a pressure-sensitive adhesive layer laminated on the other major surface of the substrate layer, in which a specular reflectance of visible light on the surface of the tape near to the colored layer is 2.0% or smaller.

According to the pressure-sensitive adhesive tape of the aforementioned embodiment, the matting property on the surface of the tape near to the colored layer, the surface of the tape being on the side to be viewed, can be improved and a reflection or a glare on the surface thereof can be reduced.

In the pressure-sensitive adhesive tape according to the aforementioned embodiment, the plastic material may be polyethylene terephthalate (PET). Black pigment maybe added to the substrate layer. The black pigment maybe carbon black. The colored layer may be a black printed layer. The pressure-sensitive adhesive layer may contain an acrylic polymer whose monomer major component is a (meth) acrylic acid alkyl ester.

Appropriate combinations of the aforementioned respective elements can also be included in the scope of the invention that seeks patent protection by the present application.

### BRIEF DESCRIPTION OF THE DRAWINGS

Embodiments will now be described, by way of example only, with reference to the accompanying drawing which is meant to be exemplary, not limiting, in which:

FIG. 1 is a schematic sectional view illustrating a structure of a pressure-sensitive adhesive tape 10 according to an embodiment.

### DETAILED DESCRIPTION OF THE INVENTION

The invention will now be described by reference to the preferred embodiments. This does not intend to limit the scope of the present invention, but to exemplify the invention.

Hereinafter, the preferred embodiments of the present invention will de described with reference to the accompanying drawing.

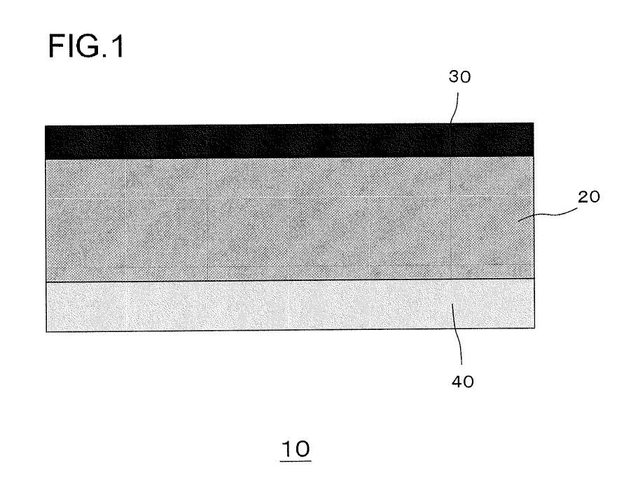

FIG. 1 is a schematic sectional view illustrating a structure of a pressure-sensitive adhesive tape 10 according to an embodiment. The pressure-sensitive adhesive tape 10 comprises a substrate layer 20, a colored layer 30, and a pressure-sensitive adhesive layer 40. In the pressure-sensitive adhesive tape 10 according to the embodiment, a specular reflectance of visible light on the surface of the tape near to the colored layer 30 is 2.0% or smaller.

In the present embodiment, the specular reflectance of visible light on the surface of the tape near to the colored layer is 2.0% or smaller, preferably 1.0% or smaller, and more preferably 0.7% or smaller. By making the specular reflectance of visible light to be 2.0% or smaller, a reflection or a glare on the back surface of the tape can be reduced; the presence of the tape becomes hardly noticeable; and the design of an article to which the tape is to be attached can be improved. In the invention, the specular reflectance of visible light is a value measured in the following way:
apparatus: U-4100 Spectrophotometer (made by Hitachi, Ltd.);
wavelength range: 380 nm to 780 nm;
light incident angle: 5°; and
wavelength scanning speed (scan speed): 300 nm/min.

The specular reflectance of visible light is determined to be an average of specular reflectances in a wavelength range of 380 nm to 780 nm.

A plastic material is used as the substrate layer 20. The plastic material is not particularly limited, but examples thereof include: polyesters, such as polyethylene terephthalate and polybutylene terephthalate; polyolefins, such as polyester, polyethylene, and polypropylene; polyimide; polyamide; and polycarbonate, etc. The substrate layer 20 is obtained by forming the plastic material into a film shape or sheet shape. The substrate layer 20 maybe transparent or opaque itself, but black pigment, such as carbon black, maybe added to the substrate layer 20, from the viewpoint of reducing the specular reflectance of visible light. That is, A substrate formed by adding black pigment, such as carbon black, to a plastic material and by forming into a film shape or sheet shape is preferred as the substrate layer 20. The thickness of the substrate layer 20 is not particularly limited, but, for example, within a range of 5 to 500 μm, and preferably within a range of 10 to 100 μm.

The colored layer 30 is laminated on one major surface of the substrate layer 20. In the present embodiment, the colored layer 30 is provided for making the specular reflectance of visible light to be 2.0% or smaller, and is a black printed layer formed by printing, for example, black ink on the substrate layer 20. Other than the process, the colored layer 30 can be formed by a process, such as gravure printing or screen printing. The thickness of the colored layer 30 is not particularly limited, but, for example, within a range of 1 μm to 10 μm.

The pressure-sensitive adhesive layer 40 is laminated on the other major surface of the substrate layer 20. The pressure-sensitive adhesive layer 40 is not particularly limited, but various pressure-sensitive adhesives, such as an acrylic pressure-sensitive adhesive, rubber pressure-sensitive adhesive, and silicone pressure-sensitive adhesive, can be used. Among them, an acrylic pressure-sensitive adhesive whose major component is an acrylic polymer (A) can be preferably used. The acrylic polymer (A) contains, as a monomer unit, a (meth) acrylic acid alkyl ester having a linear or branched C₁₋₂₀ alkyl group in an amount of 50% by mass or more. The (meth) acrylic acid alkyl esters having a C₁₋₂₉alkyl group can be used alone or in combination of two or more thereof for the acrylic polymer (A). The acrylic polymer (A) can be obtained by polymerizing a (meth)acrylic acid alkyl ester (with the use of, for example, solution polymerization, emulsion polymerization, UV polymerization), along with a polymerization initiator.

The ratio of the (meth)acrylic acid alkyl ester having a C₁₋₂₀ alkyl group is 50% by mass or more and 99.9% by mass or less, preferably 60% by mass or more and 95% by mass or less, and more preferably 70% by mass or more and 93% by mass or less, based on the total mass of the monomer components for preparing the acrylic polymer (A).

Examples of the (meth)acrylic acid alkyl ester having a C₁₋₂₀ alkyl group include, for example: (meth) acrylic acid C₁₋₂₀ alkyl esters, preferably (meth)acrylic acid C₂₋₁₄ alkyl esters, more preferably (meth)acrylic acid C₂₋₁₀ alkyl esters, such as (meth)acrylic acid methyl, (meth)acrylic acid ethyl, (meth)acrylic acid propyl, (meth)acrylic acid isopropyl, (meth)acrylic acid butyl, (meth)acrylic acid isobutyl, (meth)acrylic acid s-butyl, (meth)acrylic acid t-butyl, (meth)acrylic acid pentyl, (meth)acrylic acid isopentyl, (meth)acrylic acid hexyl, (meth)acrylic acid heptyl, (meth)acrylic acid octyl, (meth)acrylic acid 2-ethylhexyl, (meth)acrylic acid isooctyl, (meth)acrylic acid nonyl, (meth)acrylic acid isononyl, (meth)acrylic acid decyl, (meth)acrylic acid isodecyl, (meth)acrylic acid undecyl, (meth)acrylic acid dodecyl, (meth)acrylic acid tridecyl, (meth)acrylic acid tetradecyl, (meth)acrylic acid pentadecyl, (meth)acrylic acid hexadecyl, (meth)acrylic acid heptadecyl, (meth)acrylic acid octadecyl, (meth)acrylic acid nonadecyl, and (meth)acrylic acid eicosyl. In addition, the “(meth)acrylic acid alkyl ester” means an acrylic acid alkyl ester and/or a methacrylic acid alkyl ester, and all of the “(meth) . . . ” expressions have the same meaning.

Examples of (meth)acrylic acid esters other than the (meth)acrylic acid alkyl esters include, for example: (meth)acrylic acid esters having an alicyclic hydrocarbon group, such as cyclopentyl(meth)acrylate, cyclohexyl(meth)acrylate, and isobornyl(meth)acrylate; (meth)acrylic acid esters having an aromatic hydrocarbon group, such as phenyl(meth)acrylate; and (meth)acrylic acid esters obtained from terpene compound derivative alcohols, etc.

For the purpose of modifying cohesive force, heat resistance, and cross-linking property, etc., the acrylic polymer (A) may contain, if necessary, another monomer component (copolymerizable monomer) that is copolymerizable with the (meth)acrylic acid alkyl ester. Accordingly, the acrylic polymer (A) may contain a copolymerizable monomer along with the (meth)acrylic acid alkyl ester as a major component. A monomer having a polar group can be preferably used as the copolymerizable monomer.

Specific examples of the copolymerizable monomer include: carboxyl group-containing monomers, such as acrylic acid, methacrylic acid, carboxy ethyl acrylate, carboxy pentyl acrylate, itaconic acid, maleic acid, fumaric acid, crotonic acid, and isocrotonic acid; hydroxyl group-containing monomers, such as (meth)acrylic acid hydroxyalkyls including (meth)acrylic acid hydroxyethyl, (meth)acrylic acid hydroxypropyl, (meth)acrylic acid hydroxybutyl, (meth)acrylic acid hydroxyhexyl, (meth)acrylic acid hydroxyoctyl, (meth)acrylic acid hydroxydecyl, (meth)acrylic acid hydroxylauryl, and (4-hydroxymethyl cyclohexyl)methyl methacrylate; acid anhydride group-containing monomers, such as maleic acid anhydride and itaconic acid anhydride; sulfonic acid group-containing monomers, such as styrene sulfonic acid, allyl sulfonic acid, 2-(meth)acrylamide-2-methylpropanesulfonic acid, (meth)acrylamide propanesulfonic acid, sulfopropyl(meth)acrylate, and (meth)acryloyloxy naphthalenesulfonic acid; phosphate group-containing monomers, such as 2-hydroxyethyl acryloyl phosphate; (N-substituted)amide monomers, such as (meth)acrylamide, N,N-dimethyl(meth)acrylamide, N,N-diethyl(meth)acrylamide, N-isopropyl(meth)acrylamide, N-butyl(meth)acrylamide, N-methylol(meth)acrylamide, N-methylolpropane(meth)acrylamide, N-methoxymethyl(meth)acrylamide, and N-butoxymethyl(meth)acrylamide; succinimide monomers, such as N-(meth)acryloyloxy methylene succinimide, N-(meth)acryloyl-6-oxy hexamethylene succinimide, and N-(meth)acryloyl-8-oxy hexamethylene succinimide; maleimide monomers, such as N-cyclohexylmaleimide, N-isopropylmaleimide, N-laurylmaleimide, and N-phenylmaleimide; itaconimide monomers, such as N-methylitaconimide, N-ethylitaconimide, N-butylitaconimide, N-octylitaconimide, N-2-ethylhexylitaconimide, N-cyclohexylitaconimide, and N-laurylitaconimide; vinyl esters, such as vinyl acetate and vinyl propionate; nitrogen-containing heterocyclic monomers, such as N-vinyl-2-pyrrolidone, N-methylvinylpyrrolidone, N-vinylpyridine, N-vinylpiperidone, N-vinylpyrimidine, N-vinylpiperazine, N-vinylpyrazine, N-vinylpyrrole, N-vinylimidazole, N-vinyloxazole, N-(meth)acryloyl-2-pyrrolidone, N-(meth)acryloylpiperidine, N-(meth)acryloylpyrrolidine, N-vinyl morpholine; N-vinyl carboxylic acid amides; lactam monomers, such as N-vinyl caprolactam; cyano group-containing monomers, such as acrylonitrile and methacrylonitrile; (meth)acrylic acid aminoalkyl monomers, such as (meth)acrylic acid aminoethyl, (meth)acrylic acid N,N-dimethylaminoethyl, (meth)acrylic acid N,N-dimethylaminoethyl, and (meth)acrylic acid t-butylaminoethyl; (meth)acrylic acid alkoxy alkyl monomers, such as (meth)acrylic acid methoxyethyl and (meth)acrylic acid ethoxyethyl; styrene monomers, such as styrene and α-methylstyrene; epoxy group-containing acrylic monomers, such as (meth)acrylic acid glycidyl; glycol acrylic ester monomers, such as (meth)acrylic acid polyethylene glycol, (meth)acrylic acid polypropylene glycol, (meth)acrylic acid methoxy ethylene glycol, and (meth)acrylic acid methoxy polypropylene glycol; acrylic acid ester monomers having a heterocycle, halogen atom, silicon atom, or the like, such as (meth)acrylic acid tetrahydrofurfuryl, fluorine(meth)acrylate, and silicone(meth)acrylate; olefin monomers, such as isoprene, butadiene, and isobutylene; vinyl ether monomers, such as methyl vinyl ether and ethyl vinyl ether; vinyl esters, such as vinyl acetate and vinyl propionate aromatic vinyl compounds, such as styrene and vinyl toluene; olefins or dienes, such as ethylene, butadiene, isoprene, and isobutylene; vinyl ethers, such as vinyl alkyl ether; vinyl chloride; (meth)acrylic acid alkoxy alkyl monomers, such as (meth)acrylic acid methoxyethyl and (meth)acrylic acid ethoxyethyl; sulfonic acid group-containing monomers, such as vinyl sulfonate sodium; imide group-containing monomers, such as cyclohexyl maleimide and isopropyl maleimide; isocyanate group-containing monomers, such as 2-isocyanate ethyl(meth)acrylate; fluorine atom-containing (meth)acrylate; and silicon atom-containing (meth)acrylate, etc. These copolymerizable monomers can be used alone or in combination of two or more thereof.

When the acrylic polymer (A) contains the copolymerizable monomer along with the (meth)acrylic acid alkyl ester as a major component, carboxyl group-containing monomers can be preferably used. Among them, an acrylic acid can be preferably used. The use amount of the copolymerizable monomer is not particularly limited, but the monomer can be used in an amount within a range of 0.1 to 30% by mass, preferably within a range of 0.5 to 20% by mass, and more preferably within a range of 1 to 15% by mass, based on the total mass of the monomer components for preparing the acrylic polymer (A).

By containing 0.1% by mass or more of the copolymerizable monomer, a decrease in the cohesive force of the pressure-sensitive adhesive tape can be suppressed and large shear force can be obtained. Also, by containing 30% by mass or less of the copolymerizable monomer, it can be suppressed that the cohesive force may become too large, and accordingly the tackiness at normal temperature (25° C.) can be improved.

A polyfunctional monomer may be contained, if necessary, in the acrylic polymer (A) in order to adjust the cohesive force of the acrylic pressure-sensitive adhesive layer to be formed.

Examples of the polyfunctional monomer include, for example: (poly)ethylene glycol di(meth)acrylate, (poly)propylene glycol di(meth)acrylate, neopentyl glycol di(meth)acrylate, pentaerythritol di(meth)acrylate, pentaerythritol tri(meth)acrylate, dipentaerythritol hexa(meth)acrylate, 1,2-ethylene glycol di(meth)acrylate, 1,6-hexanediol di(meth)acrylate, 1,12-dodecane diol di(meth)acrylate, trimethylolpropane tri(meth)acrylate, tetramethylol methane tri(meth)acrylate, allyl(meth)acrylate, vinyl(meth)acrylate, divinylbenzene, epoxy acrylate, polyester acrylate, urethane acrylate, etc. Among them, trimethylolpropane tri(meth)acrylate, hexanediol di(meth)acrylate, and dipentaerythritol hexa(meth)acrylate can be preferably used. The polyfunctional (meth)acrylates can be used alone or in combination of two or more thereof.

The use amount of the polyfunctional monomer is changed depending on the molecular weight or the number of functional groups thereof, but the polyfunctional monomer is added in an amount within a range of 0.01 to 3.0% by mass, preferably within a range of 0.02 to 2.0% by mass, and more preferably within a range of 0.03 to 1.0% by mass, based on the total mass of the monomer components for preparing the acrylic polymer (A).

If the use amount of the polyfunctional monomer is more than 3.0% by mass based on the total mass of the monomer components for preparing the acrylic polymer (A), there are sometimes the cases where, for example, the cohesive force of the pressure-sensitive adhesive layer becomes too large and accordingly the adhesive force is decreased. On the other hand, if the use amount thereof is less than 0.01% by mass, there are sometimes the cases where, for example, the cohesive force of the pressure-sensitive adhesive layer is decreased.

### <Polymerization Initiator>

In preparing the acrylic polymer (A), the acrylic polymer (A) can be easily formed by a curing reaction using heat or ultraviolet rays with the use of a polymerization initiator, such as thermal polymerization initiator, photo-polymerization initiator (photo-initiator), or the like. In particular, a thermal polymerization initiator can be preferably used in terms of the advantage that a polymerization time can be shortened. The polymerization initiators can be used alone or in combination of two or more thereof.

Examples of the thermal polymerization initiator include, for example: azo polymerization initiators (for example, 2,2′-azobisisobutyronitrile, 2,2′-azobis-2-methylbutyronitrile, 2,2′-azobis(2-methylpropionic acid)dimethyl, 4,4′-azobis-4-cyanovalerianic acid, azobis isovaleronitrile, 2,2′-azobis(2-amidinopropane)dihydrochloride, 2,2′-azobis[2-(5-methyl-2-imidazoline-2-yl)propane]dihydrochloride, 2,2′-azobis(2-methylpropionamidine)disulfate, and 2,2′-azobis (N,N′-dimethyleneisobutylamidine)dihydrochloride, etc.); peroxide polymerization initiators (for example, dibenzoyl peroxide, t-butyl permaleate, and lauroyl peroxide, etc.); and redox polymerization initiators, etc.

The use mount of the thermal polymerization initiator is not particularly limited, but only has to be within a conventional range in which it can be used as a thermal polymerization initiator.

The photo-polymerization initiator is not particularly limited, but, for example, a benzoin ether photo-polymerization initiator, acetophenone photo-polymerization initiator, α-ketol photo-polymerization initiator, aromatic sulfonyl chloride photo-polymerization initiator, photoactive oxime photo-polymerization initiator, benzoin photo-polymerization initiator, benzyl photo-polymerization initiator, benzophenone photo-polymerization initiator, ketal photo-polymerization initiator, thioxanthone photo-polymerization initiator, acylphosphine oxide photo-polymerization initiator, or the like, can be used.

Specific examples of the benzoin ether photo-polymerization initiator include, for example: benzoin methyl ether, benzoin ethyl ether, benzoin propyl ether, benzoin isopropyl ether, benzoin isobutyl ether, 2,2-dimethoxy-1,2-diphenylethane-1-one [product name: IRGACURE 651, made by Ciba Speciality Chemicals Inc.], and Anisoin, etc. Specific examples of the acetophenone photo-polymerization initiator include, for example: 1-hydroxycyclohexyl phenyl ketone [product name: IRGACURE 184, made by Ciba Speciality Chemicals Inc.], 4-phenoxy dichloroacetophenone, 4-t-butyl-dichloroacetophenone, 1-[4-(2-hydroxyethoxy)-phenyl]-2-hydroxy-2-methyl-1-propane-1-one [product name: IRGACURE 2959, made by Ciba Speciality Chemicals Inc.], 2-hydroxy-2-methyl-1-phenyl-propane-1-one [product name: DAROCUR 1173, made by Ciba Speciality Chemicals Inc.], and methoxy acetophenone, etc. Specific examples of the α-ketol photo-polymerization initiator include, for example: 2-methyl-2-hydroxy propiophenone and 1-[4-(2-hydroxyethyl)-phenyl]-2-hydroxy-2-methylpropane-1-one, etc. Specific examples of the aromatic sulfonyl chloride photo-polymerization initiator include, for example, 2-naphthalene sulfonyl chloride, etc. Specific examples of the photoactive oxime photo-polymerization initiator include, for example, 1-phenyl-1,2-propanedione-2-(O-ethoxycarbonyl)-oxime, etc.

Specific examples of the benzoin photo-polymerization initiator include, for example, benzoin, etc. Specific examples of the benzyl photo-polymerization initiator include, for example, benzyl, etc. Specific examples of the benzophenone photo-polymerization initiators include, for example, benzophenone, benzoylbenzoic acid, 3,3′-dimethyl-4-methoxybenzophenone, polyvinyl benzophenone, and a-hydroxy cyclohexyl phenyl ketone, etc. Specific examples of the ketal photo-polymerization initiator include, for example, benzyl dimethyl ketal, etc. Specific examples of the thioxanthone photo-polymerization initiator include, for example, thioxanthone, 2-chlorothioxanthone, 2-methyl thioxanthone, 2,4-dimethyl thioxanthone, isopropyl thioxanthone, 2,4-dichloro thioxanthone, 2,4-diethyl thioxanthone, isopropyl thioxanthone, 2,4-diisopropyl thioxanthone, and dodecyl thioxanthone, etc.

Examples of the acylphosphine photo-polymerization initiator include, for example: bis(2,6-dimethoxybenzoyl)phenylphosphine oxide, bis(2,6-dimethoxybenzoyl)(2,4,4-trimethylpentyl)phosphine oxide, bis(2,6-dimethoxybenzoyl)-n-butyl phosphine oxide, bis(2,6-dimethoxybenzoyl)-(2-methylpropane-1-yl)phosphine oxide, bis(2,6-dimethoxybenzoyl)-(1-methylpropane-1-yl)phosphine oxide, bis(2,6-dimethoxybenzoyl)-t-butylphosphine oxide, bis(2,6-dimethoxybenzoyl)cyclohexylphosphine oxide, bis(2,6-dimethoxybenzoyl)octylphosphine oxide, bis(2-methoxybenzoyl)(2-methylpropane-1-yl)phosphine oxide, bis(2-methoxybenzoyl)(1-methylpropane-1-yl)phosphine oxide, bis(2,6-diethoxybenzoyl)(2-methylpropane-1-yl)phosphine oxide, bis(2,6-diethoxybenzoyl)(1-methylpropane-1-yl)phosphine oxide, bis(2,6-dibutoxybenzoyl)(2-methylpropane-1-yl)phosphine oxide, bis(2,4-dimethoxybenzoyl)(2-methypropane-1-yl)phosphine oxide, bis(2,4,6-trimethylbenzoyl)(2,4-dipentoxyphenyl)phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, bis(2,6-dimethoxybenzoyl)benzyl phosphine oxide, bis(2,6-dimethoxybenzoyl)-2-phenylpropyl phosphine oxide, bis(2,6-dimethoxybenzoyl)-2-phenylethyl phosphine oxide, 2,6-dimethoxybenzoyl benzylbutylphosphine oxide, 2,6-dimethoxybenzoyl benzyloctylphosphine oxide, bis(2,4,6-trimethylbenzoyl)-2,5-diisopropylphenylphosphine oxide, bis(2,4,6-trimethylbenzoyl)-2-methylphenylphosphine oxide, bis(2,4,6-trimethylbenzoyl)-4-methylphenylphosphine oxide, bis(2,4,6-trimethylbenzoyl)-2,5-diethylphenylphosphine oxide, bis(2,4,6-trimethylbenzoyl)-2,3,5,6-tetramethylphenylphosphin e oxide, bis(2,4,6-trimethyl benzoyl)-2,4-di-n-butoxy phenylphosphine oxide, 2,4,6-trimethylbenzoyl diphenylphosphine oxide, bis(2,6-dimethoxybenzoyl)-2,4,4-trimethylpentylphosphine oxide, bis(2,4,6-trimethylbenzoyl)isobutylphosphine oxide, 2,6-dimethoxybenzoyl-2,4,6-trimethylbenzoyl-n-butylphosphine oxide, bis(2,4,6-trimethylbenzoyl)phenylphosphine oxide, bis(2,4,6-trimethylbenzoyl)-2,4-dibutoxyphenylphosphine oxide, 1,10-bis[bis(2,4,6-trimethylbenzoyl)phosphine oxide]decane, and tri(2-methylbenzoyl)phosphine oxide, etc.

Among them, bis(2,4,6-trimethylbenzoyl)phenylphosphine oxide [product name: IRGACURE 819, made by Ciba Speciality Chemicals Inc.], bis(2,4,6-trimethyl benzoyl)-2,4-di-n-butoxy phenylphosphine oxide, 2,4,6-trimethylbenzoyl diphenylphosphine oxide [Lucirin TPO, made by BASF], and bis(2,6-dimethoxybenzoyl)-2,4,4-trimethylpentylphosphine oxide are particularly preferable.

The use amount of the photo-polymerization initiator is not particularly limited, but the photo-polymerization initiator is combined, for example, in an amount within a range of 0.01 to 5 parts by mass, preferably within a range of 0.05 to 3 parts by mass, and more preferably within a range of 0.08 to 2 parts by mass, based on 100 parts by mass of the monomer components for preparing the acrylic polymer (A).

When the use amount of the photo-polymerization initiator is less than 0.01 parts by mass, there are sometimes the cases where a polymerization reaction becomes insufficient. If the use amount thereof is more than 5 parts by mass, there are sometimes the cases where an ultraviolet ray does not reach the inside of the pressure-sensitive adhesive layer, because the photo-polymerization initiator absorbs an ultraviolet ray, thereby causing the fear that a decrease in the rate of polymerization may be decreased. With a decrease in the molecular weight of the generated polymer being small, the cohesive force of the formed pressure-sensitive adhesive layer becomes small, and hence there are sometimes the cases where, when the pressure-sensitive adhesive layer is peeled off from a film, part of the pressure-sensitive adhesive layer remains on the film and accordingly the film cannot be reused. The photo-polymerization initiators may be used alone or in combination of two or more thereof.

In order to adjust the cohesive force, a cross-linking agent can also be used, other than the aforementioned polyfunctional monomers. Commonly-used cross-linking agents can be used as the cross-linking agent. Examples of the cross-linking agents include, for example: an epoxy cross-linking agent, isocyanate cross-linking agent, silicone cross-linking agent, oxazoline cross-linking agent, aziridine cross-linking agent, silane cross-linking gent, alkyl-etherified melamine cross-linking agent, and metal chelate cross-linking agent, etc. In particular, an isocyanate cross-linking agent or epoxy cross-linking agent can be preferably used.

Specific examples of the isocyanate cross-linking agent include: tolylene diisocyanate, hexamethylene diisocyanate, isophorone diisocyanate, xylylene diisocyanate, hydrogenated xylylene diisocyanate, diphenylmethane diisocyanate, hydrogenated diphenylmethane diisocyanate, tetramethyl xylylene diisocyanate, naphthalene diisocyanate, triphenylmethane triisocyanate, polymethylene polyphenyl isocyanate, and these adducts with polyols, such as trimethylolpropane.

Examples of the epoxy cross-linking agent include: bisphenol A, epichlorohydrin type epoxy resin, ethyleneglycidylether, polyethylene glycol diglycidyl ether, glycerin diglycidyl ether, glycerin triglycidyl ether, 1,6-hexanediol glycidyl ether, trimethylolpropane triglycidyl ether, diglycidyl aniline, N,N,N′,N′-tetraglycidyl-m-xylylenediamine, and 1,3-bis(N,N-diglycidyl aminomethyl)cyclohexane, etc.

Various additives may be blended in the pressure-sensitive adhesive. Examples of such additives include, for example: cross-linking agents, such as isocyanate cross-linking agent and epoxy cross-linking agent; tackifiers, such as rosin derivative resin, polyterpene resin, petroleum resin, and oil soluble phenol resin; plasticizers; fillers; anti-aging agents; surfactants; and pigments (colorants), etc.

A method of forming the pressure-sensitive adhesive layer is not particularly limited, but is formed by, for example, coating the pressure-sensitive adhesive on an appropriate supporting body, such as a separator or substrate, to form a pressure-sensitive adhesive layer, and then by drying or curing the coated layer (curing with heat or active energy rays), if needed. In curing the coated layer with active energy rays (light curing), a photo-polymerization reaction is inhibited by the oxygen in the air; accordingly, it is preferable to block the oxygen by laminating an appropriate supporting body, such as a separator or substrate, on the pressure-sensitive adhesive layer, or by performing light curing under nitrogen atmosphere. The appropriate supporting body to be used in forming the pressure-sensitive adhesive layer may be peeled off at an appropriate timing during the formation of the pressure-sensitive adhesive tape or peeled off when the produced pressure-sensitive adhesive tape is used.

The thickness of the pressure-sensitive adhesive layer can be appropriately selected in accordance with the use purpose of the pressure-sensitive adhesive tape, but is, for example, within a range of 1 to 300 μm, preferably within a range of 10 to 250 μm, and more preferably within a range of approximately 30 to 200 μm. If the thickness thereof is too small, there are sometimes the cases where the adhesive force enough for holding an adherend cannot be obtained.

According to the pressure-sensitive adhesive tape described above, a reflection or a glare on the back surface of the tape, the back surface being a surface to be viewed, can be remarkably suppressed, and accordingly it can be suppressed that the design of an adherend to which the tape is to be adhered may be impaired.

### EXAMPLE 1

A colored layer having a thickness of 6 μm was formed by printing black ink on the whole of one surface of a PET film (transparent) having a thickness of 38 μm. An acrylic pressure-sensitive adhesive layer (thickness: 25 μm) was formed on the other surface of the PET film, so that a pressure-sensitive adhesive tape was produced.

### EXAMPLE 2

A colored layer having a thickness of 6 μm was formed by printing black ink on the whole of one surface of a PET film (transparent) having a thickness of 75 μm. An acrylic pressure-sensitive adhesive layer (thickness: 25 μm) was formed on the other surface of the PET film, so that a pressure-sensitive adhesive tape was produced.

### EXAMPLE 3

A colored layer having a thickness of 6 μm was formed by printing black ink on the whole of one surface of a PET film (black) having a thickness of 38 μm produced by kneading 30 parts by mass of black pigment (carbon black) into 100 parts by mass of polyethylene terephthalate. An acrylic pressure-sensitive adhesive layer (thickness: 25 μm) was formed on the other surface of the PET film, so that a pressure-sensitive adhesive tape was produced.

### COMPARATIVE EXAMPLE 1

A pressure-sensitive adhesive tape was produced in the same way as in Example 3, except that the PET film having a thickness of 38 μm used in Example 3 was also used and a colored layer was not formed.

### (Measurement of Specular Reflectance of Visible Light)

In the pressure-sensitive adhesive tape obtained in each of Examples 1 to 3 and Comparative Example 1, the specular reflectance of visible light on the back surface of the tape (in each of Examples 1 to 3, on the surface near to the colored layer; in Comparative Example 1, on the surface of the PET film) was measured.

### <Measurement Conditions of Specular Reflectance of Visible Light)

Apparatus: U-4100 Spectrophotometer (made by Hitachi, Ltd.);
Wavelength Range: 380 nm to 780 nm;
Light Incident Angle: 5°
Wavelength Scanning Speed: 300 nm/min.

The specular reflectance of visible light is determined to be an average of specular reflectances in a wavelength range of 380 nm to 780 nm. The obtained results are shown in Table 1.

TABLE 1

| | SPECULAR REFLECTANCE |
|---|---|
| | OF VISIBLE LIGHT (%) |
| EXAMPLE 1 | 0.19 |
| EXAMPLE 2 | 0.68 |
| EXAMPLE 3 | 0.10 |
| COMPARATIVE | 5.04 |
| EXAMPLE 1 | |

In the pressure-sensitive adhesive tape of Examples 1 to 3, the specular reflectance of visible light on the surface of the tape near to the colored layer, the surface being the back surface of the tape, is 2.0% or smaller. On the other hand, in the pressure-sensitive adhesive tape of Comparative Example 1, the specular reflectance of visible light on the back surface of the tape was greatly larger than 2.0% and a reflection and a glare were remarkable.

What is claimed is:

1. A pressure-sensitive adhesive tape comprising:
a substrate layer made of a plastic material;
a colored layer laminated on one major surface of the substrate layer; and
a pressure-sensitive adhesive layer laminated on the other major surface of the substrate layer, wherein
a specular reflectance of visible light on the surface of the tape near to the colored layer is 2.0% or smaller.

2. The pressure-sensitive adhesive tape according to claim 1, wherein
the plastic material is polyethylene terephthalate.

3. The pressure-sensitive adhesive tape according to claim 1, wherein
black pigment is added to the substrate layer.

4. The pressure-sensitive adhesive tape according to claim 3, wherein
the black pigment is carbon black.

5. The pressure-sensitive adhesive tape according to claim 1, wherein
the colored layer is a black printed layer.

6. The pressure-sensitive adhesive tape according to claim 1, wherein
the pressure-sensitive adhesive layer contains an acrylic polymer whose monomer major component is a (meth)acrylic acid alkyl ester.

7. The pressure-sensitive adhesive tape according to claim 2, wherein
black pigment is added to the substrate layer.

8. The pressure-sensitive adhesive tape according to claim 7, wherein
the black pigment is carbon black.

9. The pressure-sensitive adhesive tape according to claim 2, wherein
the colored layer is a black printed layer.

10. The pressure-sensitive adhesive tape according to claim 3, wherein
the colored layer is a black printed layer.

11. The pressure-sensitive adhesive tape according to claim 4, wherein
the colored layer is a black printed layer.

12. The pressure-sensitive adhesive tape according to claim 7, wherein
the colored layer is a black printed layer.

13. The pressure-sensitive adhesive tape according to claim 8, wherein
the colored layer is a black printed layer.

14. The pressure-sensitive adhesive tape according to claim 2, wherein
the pressure-sensitive adhesive layer contains an acrylic polymer whose monomer major component is a (meth)acrylic acid alkyl ester.

15. The pressure-sensitive adhesive tape according to claim 3, wherein
the pressure-sensitive adhesive layer contains an acrylic polymer whose monomer major component is a (meth)acrylic acid alkyl ester.

16. The pressure-sensitive adhesive tape according to claim 4, wherein
the pressure-sensitive adhesive layer contains an acrylic polymer whose monomer major component is a (meth)acrylic acid alkyl ester.

17. The pressure-sensitive adhesive tape according to claim 5, wherein
the pressure-sensitive adhesive layer contains an acrylic polymer whose monomer major component is a (meth)acrylic acid alkyl ester.

18. The pressure-sensitive adhesive tape according to claim 7, wherein
the pressure-sensitive adhesive layer contains an acrylic polymer whose monomer major component is a (meth)acrylic acid alkyl ester.

19. The pressure-sensitive adhesive tape according to claim 8, wherein
the pressure-sensitive adhesive layer contains an acrylic polymer whose monomer major component is a (meth)acrylic acid alkyl ester.

20. The pressure-sensitive adhesive tape according to claim 9, wherein
the pressure-sensitive adhesive layer contains an acrylic polymer whose monomer major component is a (meth)acrylic acid alkyl ester.
